(19) United States
(12) Patent Application Publication
(10) Pub. No.: US 2026/0131401 A1
(43) Pub. Date: May 14, 2026

(54) GAS-FLOW NOZZLE FOR LASER WELDING

(71) Applicant: Corelase Oy, Tampere (FI)

(72) Inventors: Dochan LA, Seoul (KR); Jun-Yeong BAE, Bucheon-si (KR); Daniel KIM, Suwon-si (KR); Kyeongtae JEONG, Seoul (KR); Henri PAJUKOSKI, Kangasala (FI); Olli PERNU, Tampere (FI)

(73) Assignee: Corelase Oy, Tampere (FI)

(21) Appl. No.: 19/380,005

(22) Filed: Nov. 5, 2025

Related U.S. Application Data
(60) Provisional application No. 63/720,024, filed on Nov. 13, 2024.
(60) Provisional application No. 63/723,068, filed on Nov. 20, 2024.

(51) Int. Cl. B23K 26/14

(52) U.S. Cl. CPC B23K 26/1476

(57) ABSTRACT

A gas-flow nozzle for laser welding includes a central opening to transmit a laser beam from a top of the central opening to a workpiece at a bottom of the central opening. The central opening is bounded by two inward-facing opposite sides of the gas-flow nozzle. The gas-flow nozzle further includes (a) one or more lower gas-flow channels to direct a lower gas flow to the workpiece from both of the two sides bounding the central opening, (b) one or more upper gas-flow channels to direct an upper gas flow to the workpiece from both of the two sides bounding the central opening, and (c) one or more middle gas-flow channels to exhaust gas from both of the two sides of the central opening. The gas-flow nozzle is useful for laser welding prismatic battery cases. In this scenario, the upper gas flow helps prevent burning of battery-terminal insulator material.

### CROSS-REFERENCE TO RELATED APPLICATIONS

This application claims the benefit of U.S. Provisional Application No. 63/720,024, filed Nov. 13, 2024, and the benefit of U.S. Provisional Application No. 63/723,068, filed Nov. 20, 2024, the entire contents of each of which are incorporated herein by reference.

### TECHNICAL FIELD OF THE INVENTION

The present invention relates in general to laser welding near a heat-sensitive material while protecting the heat-sensitive material from heat generated by the laser welding process. The present invention relates in particular to laser welding a cap onto the case body of a prismatic battery while preventing burning of the insulator material of terminals on the cap.

### DISCUSSION OF BACKGROUND ART

There is a strong push towards carbon-emission-free transportation. This effort involves phasing out the large existing fleet of diesel- and gasoline-powered vehicles and replacing these vehicles with electric vehicles. Efficient and reliable lithium-ion batteries and cost-effective production thereof are paramount to the success of this effort.

The basic unit of a lithium-ion battery cell consists of an anode, a cathode, and a separator therebetween. The separator is infused with an electrolyte containing lithium salt. Each of the anode and the cathode includes a current collector in the form of a metal foil. Some types of lithium-ion battery cells contain only a single basic unit, while others contain multiple basic units coupled in parallel. In applications requiring high storage capacity, it is common to couple together multiple lithium-ion battery cells in series and/or parallel. For example, a battery pack for an electric vehicle contains multiple battery modules, each containing multiple lithium-ion battery cells. Particularly for electric vehicles, the objective is to achieve the highest possible energy storage capacity per volume and per weight, while ensuring reliability and keeping the manufacturing cost at an acceptable level.

Lithium-ion battery cells are being manufactured in three different cell-formats: cylindrical, prismatic, and pouch. In a cylindrical cell, a single basic unit (anode, cathode, and separator) is wound in a jelly-roll fashion and disposed in a rigid metal cylinder. The cylindrical cell is the original format used for lithium-ion batteries, but the cylindrical shape precludes efficient packaging of multiple battery cells in a battery module. The prismatic cell shape is better suited to applications, such as electric vehicles, that require many battery cells and a high energy density. Pouch cells provide further improvement in terms of achievable energy density, both per volume and per weight. Whereas a prismatic cell has a rigid metal casing similar to that of a cylindrical cell, the casing of the pouch cell is a soft polymer-coated aluminum foil that is both thinner and lighter than the rigid metal casings of prismatic and cylindrical cells.

Despite the lighter weight and thinner form factor of the pouch cell, the prismatic cell has numerous advantages that tend to favor the prismatic cell over the pouch cell in large-scale applications, such as electric vehicles, were the emphasis is on reliability, safety, durability, packing efficiency, and cost-effective manufacturing. The rigid case of the prismatic cell provides better protection against mechanical stress and punctures and helps prevent swelling, thereby offering enhanced safety and stability. The rigid case also provides useful structure for arranging many battery cells together in a battery pack and facilitates easy integration of cooling systems. Additionally, the rigid case helps prevent degradation over time, thus offering durability and a long life cycle.

The basic components of the case of a typical prismatic battery case are (a) a case body with an open top, (b) a cap to close the top, and (c) anode and cathode terminals integrated in the cap. The manufacture of such a prismatic battery cell includes welding the cap to the case body.

Beams of laser-radiation are increasingly used to weld a wide range of materials including metals and metal alloys. In laser welding, a focused laser beam locates each weld spot or seam precisely, while minimizing collateral heating and minimizing unwanted defects. Laser welding is often performed with a shielding gas. The shielding gas protects the molten material from atmospheric contamination and prevents oxidation.

### SUMMARY OF THE INVENTION

Disclosed herein is a gas-flow nozzle for a laser welding head. The nozzle produces a gas flow that is specifically tailored to laser weld in the area near a heat-sensitive material. The laser welding process may generate a plume, and a portion of the gas flow produced by the nozzle may help prevent the plume from burning the heat-sensitive material. The present gas-flow nozzle is useful for laser welding a cap onto a case body of a prismatic battery cell while avoiding burning insulator material of anode and/or cathode terminals protruding from the cap.

In one aspect of the invention, a laser welding head comprises a gas-flow nozzle that includes a central opening to transmit a laser beam from a top of the central opening to a workpiece at a bottom of the central opening. The central opening is bounded by two inward-facing opposite sides of the gas-flow nozzle. The gas-flow nozzle further includes (a) one or more lower gas-flow channels to direct a lower gas flow to the workpiece from both of the two inward-facing opposite sides bounding the central opening, (b) one or more upper gas-flow channels to direct an upper gas flow to the workpiece from both of the two inward-facing opposite sides bounding the central opening, and (c) one or more middle gas-flow channels to exhaust gas from both of the two inward-facing opposite sides bounding the central opening. The one or more lower gas-flow channels have one or more lower outlet ports at the central opening. The one or more upper gas-flow channels have one or more upper outlet ports at the central opening. The one or more middle gas-flow channels have one or more inlet ports at the central opening. The upper outlet ports are arranged in an upper layer of the gas-flow nozzle between the top and the bottom of the central opening, the lower outlet ports are arranged in a lower layer of the gas-flow nozzle farther than the upper layer from the top of the central opening, and the inlet ports are arranged in a middle layer of the gas-flow nozzle between the lower and upper layers.

### BRIEF DESCRIPTION OF THE DRAWINGS

The accompanying drawings, which are incorporated in and constitute a part of the specification, schematically illustrate preferred embodiments of the present invention, and together with the general description given above and the detailed description of the preferred embodiments given below, serve to explain principles of the present invention.

FIGS. 1A and 1B illustrate a prismatic battery cell during manufacture. FIG. 1A further illustrates a method for laser welding a cap of the prismatic battery cell onto a case body thereof, according to an embodiment.

FIGS. 2A and 2B schematically illustrate a gas-flow nozzle that may be implemented in the laser welding method of FIG. 1A to prevent burning insulator material of terminals integrated in the cap, according to an embodiment. FIG. 2A further illustrates a laser welding apparatus that utilizes the gas-flow nozzle, according to an embodiment.

FIGS. 3A-C illustrate gas-flow channels of the gas-flow nozzle of FIGS. 2A and 2B, and associated gas-flow management elements.

FIG. 4 illustrates a gas-flow nozzle useful for laser welding a prismatic battery cell with two terminals on the same cap, according to an embodiment.

FIG. 5 illustrates a gas-flow nozzle useful for laser welding near a single terminal on a cap of a prismatic battery cell, according to an embodiment.

FIG. 6 illustrates a gas-flow nozzle configured to produce annular, upper gas flow, according to an embodiment.

FIGS. 7A and 7B illustrate a gas-flow nozzle that includes a baffle to direct a lower gas flow along an oblique direction with respect to two opposite sides of the nozzle bounding a central opening thereof, according to an embodiment.

FIG. 8 illustrates exemplary advantageous use of the nozzle of FIGS. 7A and 7B when used in the laser welding method of FIG. 1A.

FIGS. 9, 10, 11, 12A and 12B illustrate respective embodiments of the baffle of the gas-flow nozzle of FIGS. 7A and 7B.

FIG. 13 illustrates a gas-flow nozzle that includes one or more perforated barriers in each lower gas-flow channel to reduce or minimize turbulence in a lower gas flow delivered to a central opening of the gas-flow nozzle, according to an embodiment.

FIG. 14 illustrates a gas-flow nozzle that includes a wire mesh in each of one or more lower gas-flow channels to reduce or minimize turbulence in a lower gas flow delivered to a central opening of the gas-flow nozzle, according to an embodiment. The gas-flow nozzle also includes a baffle to direct the lower gas flow.

FIG. 15 illustrates a gas-flow nozzle that includes a plurality of pneumatic silencers in each of one or more lower gas-flow channels to reduce or minimize turbulence in a lower gas flow delivered to a central opening of the gas-flow nozzle, according to an embodiment.

FIG. 16 illustrates a threaded pneumatic silencer, according to an embodiment.

FIGS. 17A and 17B illustrate a laser welding apparatus for laser welding a cap to a case body in a series of prismatic battery cells arranged next to each other in a lengthwise linear array, according to an embodiment.

FIG. 18 illustrates a nozzle assembly that may be implemented in the laser welding apparatus of FIGS. 17A and 17B, according to an embodiment.

FIG. 19 illustrates a modular gas-flow nozzle, according to an embodiment.

FIG. 20 illustrates a gas-flow module that may be implemented in modular embodiments of the FIG. 18 nozzle assembly to form widthwise portions of two adjacent gas-flow nozzles, according to an embodiment.

FIGS. 21A and 21B illustrate a laser welding apparatus for laser welding a cap to a case body in a series of prismatic battery cells arranged next to each other in a widthwise linear array, according to an embodiment.

FIGS. 22A and 22B illustrates a nozzle assembly that may be implemented in the laser welding apparatus of FIGS. 21A and 21B, according to an embodiment.

FIG. 23 illustrates a modular gas-flow nozzle, according to an embodiment.

FIG. 24 illustrates a gas-flow module that may be implemented in modular embodiments of the nozzle assembly of FIGS. 22A and 22B to form widthwise portions of two adjacent gas-flow nozzles, according to an embodiment.

### DETAILED DESCRIPTION OF THE INVENTION

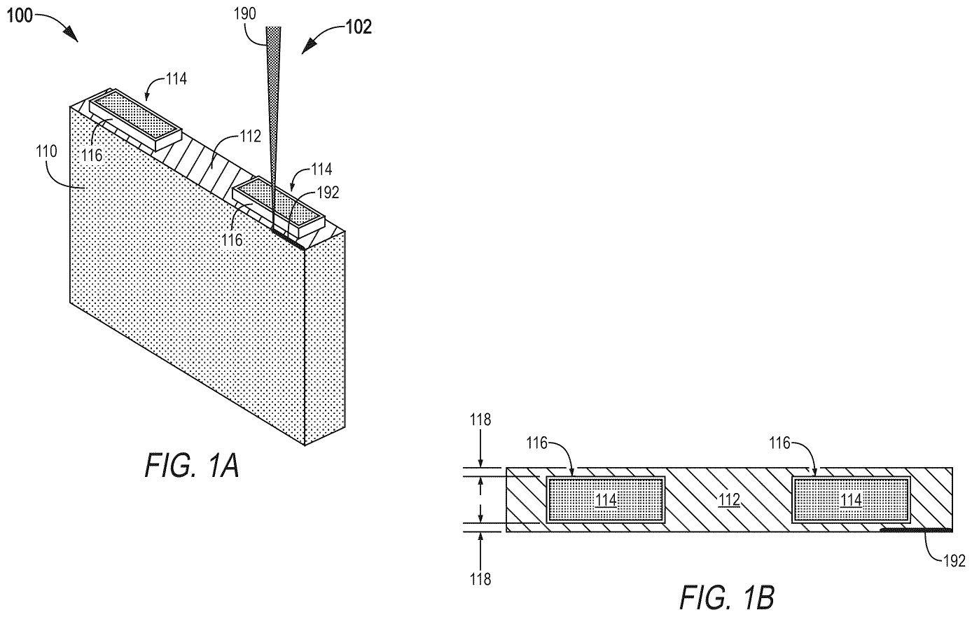

Referring now to the drawings, wherein like components are designated by like numerals, FIGS. 1A and 1B illustrate one prismatic battery cell 100 during manufacture. Battery cell 100 includes a case body 110 and a cap 112. Cap 112 includes two terminals 114 (a cathode terminal and an anode terminal). Each terminal 114 protrudes from cap 112 and includes an insulator 116. FIG. 1A is a perspective view of battery cell 100, and FIG. 1B is a top view of cap 112.

FIG. 1A further illustrates a laser welding method 102 for welding cap 112 to case body 110. Method 102 traces the interface between cap 112 and case body 110 with a laser beam 190, thereby forming a weld seam 192 along this interface. Laser beam 190 may trace the entire perimeter of cap 112. Case body 110 and cap 112 may be made of metal. Insulator 116 may be relatively heat sensitive and may be positioned close to the path traced by laser beam 190 when welding along the interface between case body 110 and cap 112. In one scenario, the distance 118 between insulator 116 and the interface between case body 110 and cap 112 is less than 10 millimeters (mm), for example in the range between 1 and 5 mm. Thus, without implementing a form of mitigation, insulator 116 may be burned by a plume, plasma, and/or heat generated by laser welding along the interface between case body 110 and cap 112.

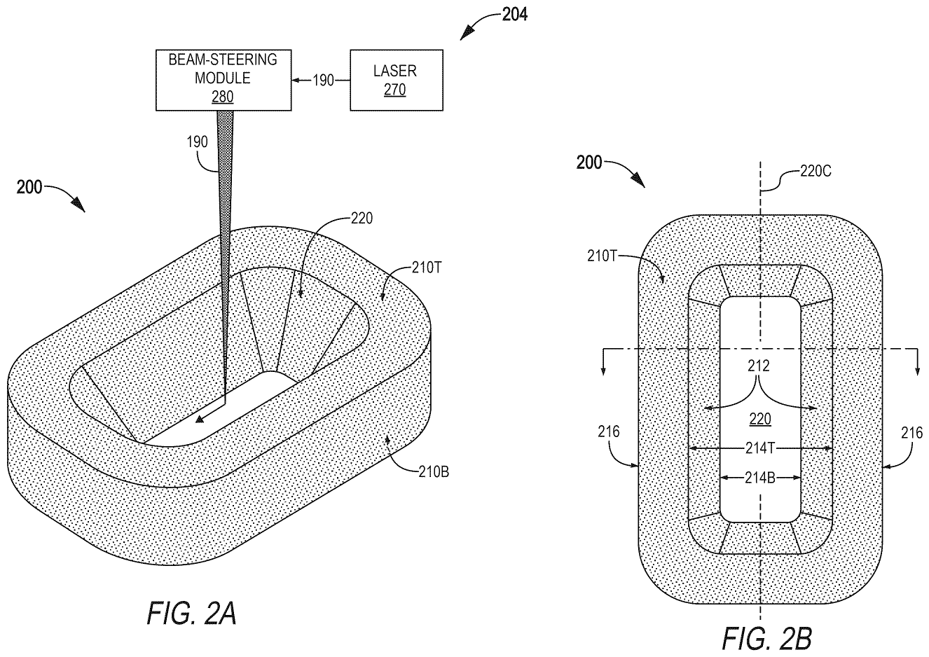

FIGS. 2A and 2B schematically illustrate one gas-flow nozzle 200 that may be used in laser welding method 102 to prevent burning of insulator 116. As shown in FIG. 2A, nozzle 200 may be implemented in a laser welding apparatus 204. In addition to nozzle 200, laser welding apparatus 204 may include a laser 270 that generates laser beam 190 and a beam-steering module 280 that steers laser beam 190 to a target location. Beam-steering module 280 may include a galvanometer. FIGS. 2A and 2B show perspective and top views, respectively, of nozzle 200. Nozzle 200 has a central opening 220 that passes through nozzle 200 from the top 210T to the bottom 210B of nozzle 200. Central opening 220 is bounded by two inward-facing, opposite sides 212 of nozzle 200. The distance 214T between sides 212 at top 210T may exceed the distance 214B between sides 212 at bottom 210B, as shown in FIG. 2B.

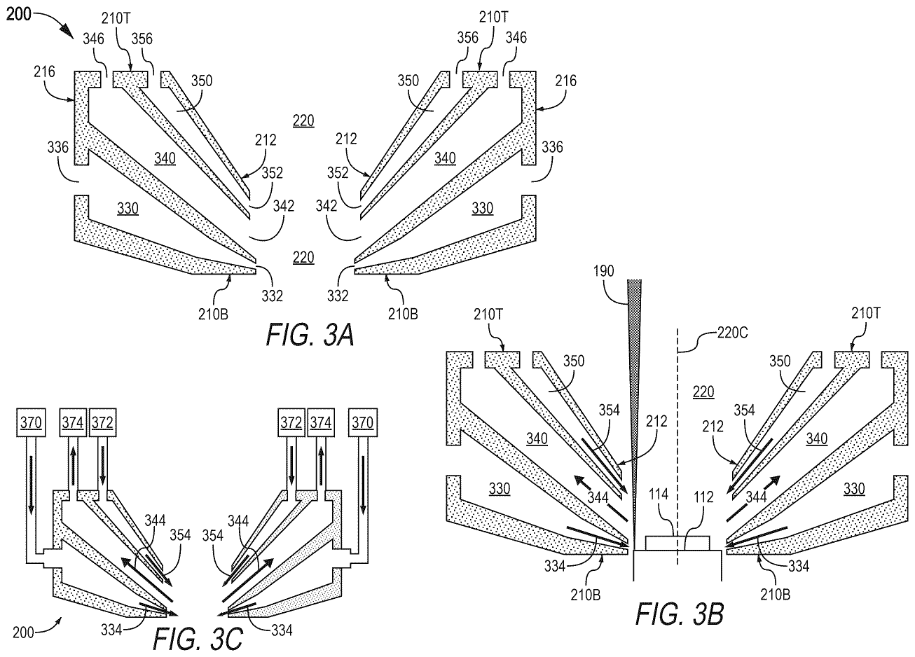

When nozzle 200 is implemented in method 102, nozzle 200 is positioned at the top of battery cell 100 such that cap 112 is at the bottom of central opening 220 and faces the top of central opening 220. The top and bottom of central opening 220 are at top 210T and bottom 210B, respectively. Battery cell 100 may protrude into central opening 220 by some amount. For example, one or both of terminals 114 may protrude into central opening 220. During laser welding, central opening 220 transmits laser beam 190 from top 210T to battery cell 100, and laser beam 190 is moved (e.g., by beam-steering module 280) within central opening 220 to trace the interface between case body 110 and cap 112. At the same time, nozzle 200 directs gas flows towards battery cell 100. Nozzle 200 has several gas flow channels for this purpose. These gas flow channels are not depicted in FIGS. 2A and 2B but are discussed in further detail in reference to FIGS. 3A and 3B. The gas flow channels of nozzle 200 are specifically designed to prevent burning of insulator 116.

FIGS. 3A-C are cross-sectional views of nozzle 200 taken along the dash-dotted line indicated in FIG. 2B. These views show gas-flow channels of nozzle 200. FIG. 3B further illustrates gas flows through the gas flow channels when nozzle 200 is used in laser welding method 102 and laser beam 190 is incident on battery cell 100 near a terminal 114. FIG. 3C further illustrates optional gas supply and extraction elements of laser welding apparatus 204. Nozzle 200 has one or more lower gas-flow channels 330, one or more upper gas-flow channels 350, and one or more middle gas-flow channels 340. In operation, lower channel(s) 330 direct a lower gas flow 334 toward battery cell 100 from both sides 212 of central opening 220, upper channel(s) 350 direct an upper gas flow 354 toward battery cell 100 from both sides 212, and middle channel(s) 340 exhaust gas from both sides 212, as indicated by exhaust flow 344. Lower gas flow 334 may include or consist of nitrogen. Upper gas flow 354 may include or consist of nitrogen and/or air.

Upper channel(s) 350 have one or more upper outlet ports 352 arranged in an upper layer that is located between the top and bottom of central opening 220. Lower channel(s) 330 have one or more lower outlet ports 332 arranged in a lower layer that is farther from the top of central opening 220. Middle channel(s) 340 have one or more inlet ports 342 arranged in a middle layer between the lower layer and the upper layer. In the depicted example, lower channel(s) 330 have one or more inlet ports 336 on exterior sides 216 of nozzle 200, middle channel(s) 340 have one or more outlet ports 346 on top 210T, and upper channel(s) 350 have one or more inlet ports 356 on top 210T. Without departing from the scope hereof, ports 336, 346, and 356 may be located elsewhere on top 210T, exterior sides 216, or bottom 210B. Each lower channel 330 and each upper channel 350 may contain one or more structural elements that homogenize the respective gas flow. In one embodiment, such structural element(s) may result in the gas flow out of the associated outlet ports being substantially laminar or at least characterized by only low-level turbulence. Each such structural element may be in the form of a perforated barrier (e.g., a mesh or rigid wall with holes), a porous barrier (e.g., a porous membrane), and/or a series of walls that create a labyrinth-like flow path.

As shown in FIG. 3C, laser welding apparatus 204 may further include (a) one or more gas sources 370 coupled to inlet port(s) 336 to supply lower gas flow 334 and (b) one or more gas sources 372 coupled to inlet port(s) 356 to supply upper gas flow 354. Alternatively, the same gas source(s) may be coupled to both inlet port(s) 336 and inlet port(s) 356 and supply both lower gas flow 334 and upper gas flow 354. Laser welding apparatus 204 may also include a gas extractor 374, e.g., a pump, coupled to outlet port(s) 346 to remove exhaust flow 344.

Lower gas flow 334 emanates from outlet port(s) 332 in a direction that is generally toward a center plane 220C of central opening 220 (see FIGS. 2B and 3B). This direction may be nearly parallel to the surface of cap 112. Lower gas flow 334 is aimed at battery cell 100 near cap 112, and may serve as a shielding gas for the laser welding process. Upper gas flow 354 emanates from outlet port(s) 352 along a direction that is toward center plane 220C and toward the bottom of central opening 220. The inclusion of upper gas flow 354 prevents burning of insulator 116 of terminal 114, or at least reduces the risk of such burning occurring. It is possible that this desirable effect is at least in part caused by the upper gas flow 354 from the two opposite sides 212 of central opening 220 “colliding” near center plane 220C. This “collision” of gas flows redirects the gas flows in an outward direction that may help force the plume, plasma, and/or heat, generated by laser welding, away from terminal 114.

In one embodiment, lower gas flow 334 is an annular gas flow, and lower outlet port(s) 332 extend around the entire perimeter of central opening 220. In this embodiment, lower channel(s) 330 may have an annular outlet port (an embodiment of lower outlet port(s) 332) that surrounds central opening 220. This annular outlet port may be segmented into a series of outlet ports distributed around central opening 220. Similarly, middle channel(s) 340 may have an annular inlet port (an embodiment of inlet port(s) 342) that surrounds central opening 220. This annular inlet port may also be segmented into a series of inlet ports distributed around central opening 220. The configuration of upper outlet ports 352 may be tailored to the laser welding task, for example to the number and positioning of terminals within central opening 220.

FIG. 4 illustrates one gas-flow nozzle 400 useful for laser welding a prismatic battery cell with two terminals on the same cap. Nozzle 400 is an embodiment of nozzle 200 optimized for the laser welding of battery cell 100 with two terminals 114 protruding from cap 112. Nozzle 400 may be positioned such that the entire perimeter of cap 112 can be accessed by laser beam 190 through central opening 220. In nozzle 400, upper channel(s) 350 have four outlet ports 452 (embodiments of outlet ports 352), arranged as two outlet ports 452 on each side 212 of central opening 220. The locations of outlet ports 452 are indicated schematically in FIG. 4. Each outlet port 452 on one side 212 is directly opposite a corresponding outlet port 452 on the opposite side 212. In the depicted scenario, the location of each pair of oppositely-located outlet ports 452 matches the location of a terminal 114.

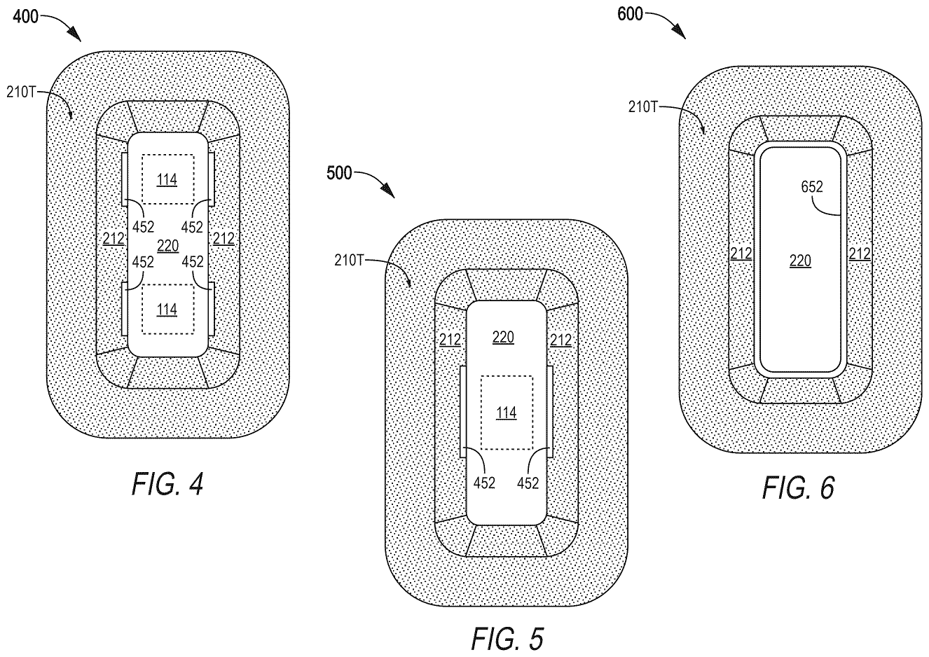

FIG. 5 illustrates one gas-flow nozzle 500 useful for laser welding a prismatic battery cell with a single terminal on a cap. Nozzle 400 is an embodiment of nozzle 200 optimized to the laser welding of a modification of battery cell 100 wherein cap 112 has only a single terminal 114. Such a prismatic battery cell may have two caps 112 located on opposite ends of the battery cell, with an anode terminal on one cap and a cathode terminal on the opposite cap. Nozzle 500 may be positioned such that the entire perimeter of cap 112 can be accessed by laser beam 190 through central opening 220. In nozzle 500, upper channel(s) 350 have a single outlet port 452 on each side 212 of central opening 220, as indicated schematically in FIG. 5. These two outlet ports 452 are directly opposite each other, and the location of this pair of oppositely-located outlet ports 452 may match the location of a terminal 114. Nozzle 500 may also be used to laser weld near a single terminal 114 on a prismatic-battery cap having one or more terminals 114.

FIG. 6 illustrates one gas-flow nozzle 600 configured to produce upper gas flow 354 as an annular gas flow. Nozzle 600 is an embodiment of nozzle 200, wherein upper channel(s) 350 have an annular outlet port 652 that surrounds central opening 220. Annular outlet port 652 is an embodiment of outlet port(s) 352. Nozzle 600 is suitable for laser welding of prismatic battery cells with one or more terminals 114 protruding from a cap 112.

Without departing from the scope hereof, each of outlet ports 452 and 652 may be segmented into several adjacent outlet ports.

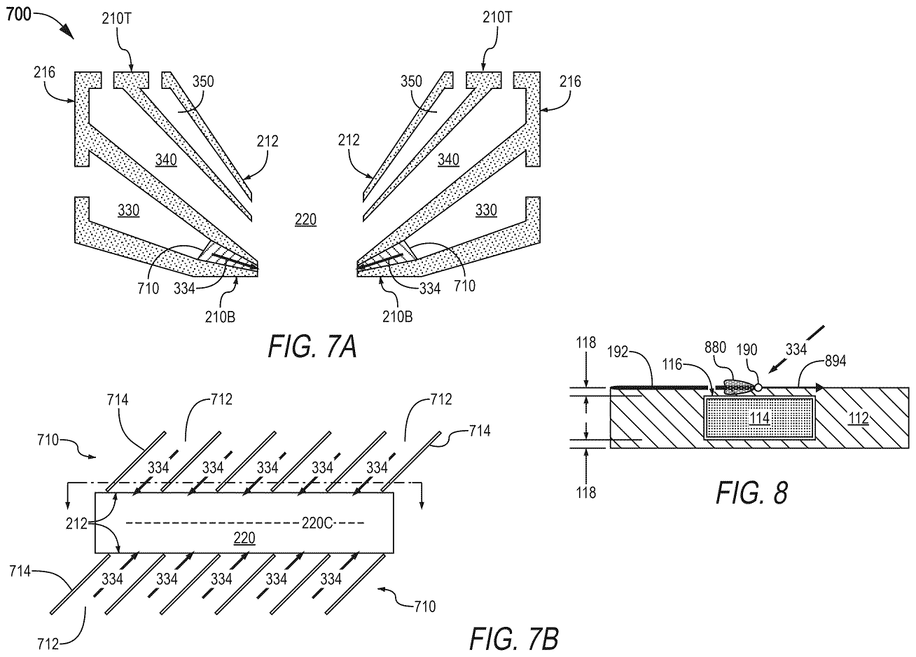

FIGS. 7A and 7B are schematic cross-sectional views of one gas-flow nozzle 700 that includes a baffle to direct lower gas flow 334 along an oblique direction with respect to sides 212. Nozzle 700 is an embodiment of nozzle 200 that includes a baffle 710 in lower channel(s) 330. The cross-sectional view in FIG. 7A is similar to that used in FIGS. 3A and 3B. The cross section depicted in FIG. 7B is taken in a plane that is orthogonal to the plane of FIG. 7A and parallel to bottom 210B.

Baffle 710 includes structural elements 714 that direct lower gas flow 334. Elements 714 define a plurality of sub-channels 712 that impose a propagation direction of lower gas flow 334. Sub-channels 712 may be separate from each other or in partly open connection with each other. Elements 714 may be walls or other directional features protruding into the space of lower channel(s) 330. More generally, elements 714 are material sections that fully or partly separate sub-channels 712 from each other. On each side 212, elements 714 are oriented such that lower gas flow 334 emanating from this side 212 is directed along a direction that is at an oblique angle to side 212. More specifically, as projected onto the plane of FIG. 7A, the direction of lower gas flow 334 out of lower channel(s) 330 is at an oblique angle to center plane 220C.

In one embodiment, baffle 710 is implemented in an annular outlet port of lower channel 330 surrounding central opening 220. In this embodiment, baffle 710 may surround central opening 220, or be present only along sides 212. In another embodiment, baffle 710 is implemented in outlet ports of lower channel 330 extending along sides 212.

FIG. 8 illustrates exemplary advantageous use of nozzle 700 in laser welding method 102. In this example, laser beam 190 is traced along the interface between cap 112 and case body 110 to form weld seam 192. As the incidence location of laser beam 190 on battery cell 100 is scanned along one side of battery cell 100 in a scanning direction 894, the flow direction of lower gas flow 334 emanating from the adjacent side 212 of nozzle 700 has a component that is counter to scanning direction 894. As a result, a plume 880 produced by the laser welding process trails the incidence location of laser beam 190, with minimal or no extent in front of the incidence location of laser beam 190. This prevents, or at least reduces, heating of plume 880 by laser beam 190. Baffle 710 of nozzle 700 therefore helps minimize the temperature of plume 880, thereby further reducing the risk of burning insulator 116. Additionally, the minimal overlap between laser beam 190 and plume 880, when using baffle 710, provides more consistent irradiation of battery cell 100 and therefore a more uniform weld seam.

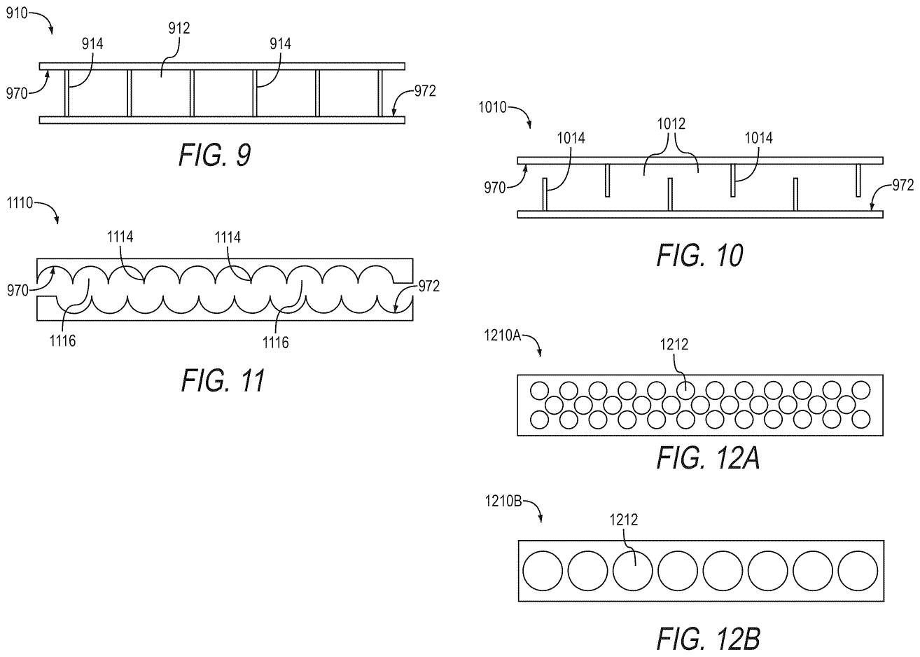

FIG. 9 is a cross-sectional view of one baffle 910 used to direct lower gas flow 334 to emanate from lower channel(s) 330 along an oblique direction with respect to sides 212. Baffle 910 is an embodiment of baffle 710. The cross section depicted in FIG. 9 is taken along the dash-dotted line in FIG. 7B. Lower gas flow 334 passes through the plane of FIG. 9 from behind the plane to in front of the plane. Baffle 910 includes a series of walls 914, each spanning between a floor 972 and a ceiling 970 of lower channel(s) 330. Baffle 910 thereby forms a series of separate sub-channels 912.

FIG. 10 is a cross-sectional view of another baffle 1010 used to direct lower gas flow 334 to emanate from lower channel(s) 330 along an oblique direction with respect to sides 212. The cross section depicted in FIG. 10 is taken along the dash-dotted line in FIG. 7B. Baffle 1010 is a modification of baffle 910 implementing walls 1014 that do not span the full distance between floor 972 and ceiling 970, but yet define a series of sub-channels 1012 that impose a corresponding propagation direction of lower gas flow 334. Walls 1014 may be alternatingly connected to floor 972 and ceiling 970, as shown in FIG. 10, all walls 1014 may be connected to one of floor 972 and ceiling 970, or walls 1014 may be otherwise connected to either one of floor 972 and ceiling 970.

FIG. 11 is a cross-sectional view of yet another baffle 1110 used to direct lower gas flow 334 to emanate from lower channel(s) 330 along an oblique direction with respect to sides 212. The cross section depicted in FIG. 11 is taken along the dash-dotted line in FIG. 7B. Baffle 1110 is a modification of the embodiment of baffle 1010 depicted in FIG. 10, with walls 1114 shaped to form a series of semicircular, or otherwise rounded, hollows 1116. A series of hollows 1116 in floor 972 is offset from a series of hollows 1116 in ceiling 970, such that the sub-channel formed by each hollow 1116 is in partly open connection with the sub-channels formed by adjacent hollows 1116.

FIGS. 12A and 12B are cross-sectional views of two other baffles 1210A and 1210B, each of which may be used to direct lower gas flow 334 to emanate from lower channel(s) 330 along an oblique direction with respect to sides 212. The cross sections depicted in FIGS. 12A and 12B are taken along the dash-dotted line in FIG. 7B. Baffles 1210A and 1210B are embodiments of baffle 710. Baffles 1210A and 1210B each forms an array of sub-channels 1212. Each sub-channel 1212 may be cylindrical. However, without departing from the scope hereof, sub-channels 1212 may have a different shape, for example characterized by a rectangular or oval cross section. Sub-channels 1212 may be arranged in a two-dimensional array as shown in FIG. 12A, or, as shown in FIG. 12B, in a one-dimensional array along the length of side 212 of central opening 220.

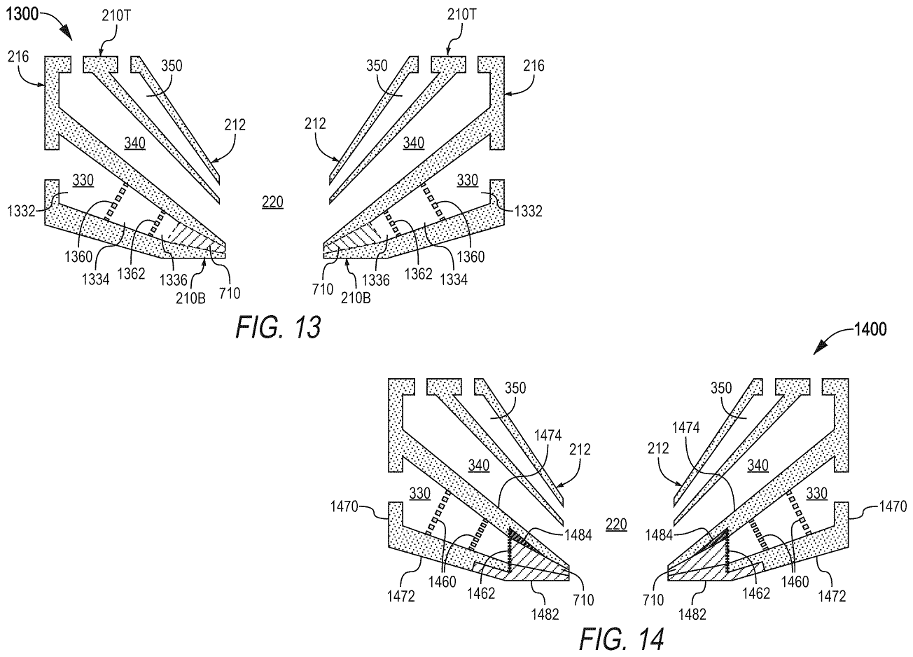

FIG. 13 is a cross-sectional view of one gas-flow nozzle 1300 that includes one or more perforated barriers in each lower channel 330 to reduce or minimize turbulence in lower gas flow 334 delivered to central opening 220. Nozzle 1300 is an embodiment of nozzle 200. In the depicted example, each lower channel 330 includes two perforated barriers 1360 and 1362 arranged such that lower gas flow 334 must first pass through perforated barrier 1360 and subsequently pass through perforated barrier 1362. Perforated barriers 1360 and 1362 divide each lower channel 330 into a series of chambers 1332, 1334, and 1336. Lower gas flow 334 passes through perforated barrier 1360 in order to flow into chamber 1334 from chamber 1332. Similarly, lower gas flow 334 passes through perforated barrier 1362 in order to flow into chamber 1336 from chamber 1334. Perforated barriers 1360 and 1362 may be pressure limiting. Each of perforated barriers 1360 and 1362 is, for example, a wire mesh or a rigid wall with holes. The depicted example with two sequential perforated barriers may be generalized to one perforated barrier or two or more sequential perforated barriers.

In embodiments with two or more sequential perforated barriers, the perforated barrier closest to central opening 220 may have the finest resolution, that is, have the highest number of holes per area. Nozzle 1300 may further include baffle 710 (see FIGS. 7A and 7B). When included in nozzle 1300, baffle 710 is positioned closer to central opening 220 than the perforated barriers of lower channel(s) 330, e.g., perforated barriers 1360 and 1362, such that lower gas flow 334 passes through the perforated barriers before reaching baffle 710.

FIG. 14 is a cross-sectional view of one gas-flow nozzle 1400 that includes at least a wire mesh in each lower channel 330 to reduce or minimize turbulence in lower gas flow 334 delivered to central opening 220, as well as baffle 710 to direct lower gas flow 334 (see FIGS. 7A and 7B). Nozzle 1400 is an embodiment of nozzle 1300 wherein the perforated barrier closest to central opening 220 is implemented as a wire mesh 1462. Nozzle 1400 is also an embodiment of nozzle 700 that further includes wire mesh 1462. Wire mesh 1462 extends around the entire perimeter of central opening 220 and may be in the form of a single strip of wire mesh material. Optionally, as depicted in FIG. 14, each lower channel 330 further includes one or more additional perforated barriers 1460 farther from central opening 220 than wire mesh 1462. Each perforated barrier 1460 may be a rigid wall with holes, or a wire mesh. The resolution of each perforated barrier 1460 is courser than that of wire mesh 1462. In one embodiment, each lower channel 330 of nozzle 1400 includes two or more sequential perforated barriers 1460, and the resolution of these perforated barriers 1460 increases in the direction toward wire mesh 1462. In this embodiment, each individual perforated barrier 1460 and wire mesh 1462 may be pressure limiting on lower gas flow 334.

The wall-structure of nozzle 1400 is specifically adapted to secure wire mesh 1462 in each lower channel 330 during assembly of nozzle 1400. Nozzle 1400 includes a main body 1470 that forms lower channel(s) 330, middle channel(s) 340, and upper channel(s) 350. In particular, main body 1470 includes walls 1472 and 1474. Wall 1472 forms a portion of the floor of lower channel(s) 330, and wall 1474 forms a portion of the ceiling of lower channel(s) 330. Nozzle 1400 further includes two annular locking elements 1482 and 1484, each of which extends around the full perimeter of central opening 220. Annular locking element 1484 is seated in a groove in wall 1474. An upper edge of wire mesh 1462 is clamped between annular locking element 1484 and wall 1474, whereby wire mesh 1462 is secured to the ceiling of lower channel(s) 330. Annular locking element 1484 may be pressure-fit into wall 1474. Annular locking element 1482 includes baffles 710 and is attached to wall 1472. Annular locking element 1482 is seated against wall 1472, with a lower edge of wire mesh 1462 clamped therebetween. Wire mesh 1462 is thereby secured to the floor of lower channel(s) 330. Annular locking element 1482 may be pressure-fit onto wall 1472, or secured to wall 1472 using fasteners.

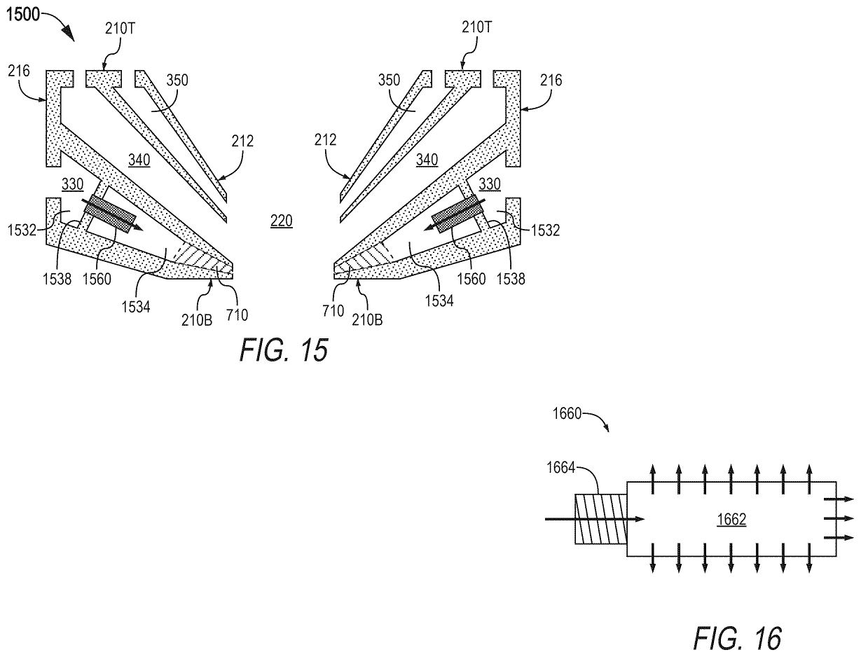

FIG. 15 is a cross-sectional view of one gas-flow nozzle 1500 that includes a plurality of pneumatic silencers 1560 in lower channel(s) 330 to reduce or minimize turbulence in lower gas flow 334 delivered to central opening 220. Nozzle 1500 is an embodiment of nozzle 200. Pneumatic silencers are also known as “pneumatic mufflers”. Pneumatic silencers 1560 are an alternative to the wire mesh and rigid perforated walls discussed above in reference to FIGS. 14 and 15 (although pneumatic silencers 1560 may also be used in combination with other solutions such as wire mesh and rigid perforated walls). Each lower channel 330 of nozzle 1500 has two chambers 1532 and 1534 separated from each other by a wall 1538. Lower gas flow 334 must pass from chamber 1532 to chamber 1534 in order to reach central opening 220. At least one pneumatic silencer 1560 is positioned in a respective opening of wall 1538. Apart from one or more such openings occupied by respective pneumatic silencers 1560, wall 1538 blocks gas flow between chambers 1532 and 1534. The one or more pneumatic silencers 1560 create a passageway for lower gas flow 334 from chamber 1532 to chamber 1534.

Each pneumatic silencer 1560 includes a porous material, for example sintered metal. The porous material creates numerous small passages allowing gas flow to pass through pneumatic silencer 1560. Each pneumatic silencer 1560 in nozzle 1500 is pressure limiting. The gas flow out of pneumatic silencer 1560 is diffuse, and any turbulence of the incident gas flow is dampened or eliminated.

The number of pneumatic silencers 1560 in nozzle 1500 may depend on a variety of parameters, such as the dimensions of central opening 220 and the dimensions of individual pneumatic silencers 1560. In one implementation, nozzle 1500 includes at least ten pneumatic silencers 1560, for example between 20 and 80 pneumatic silencers 1560, distributed around central opening 220.

FIG. 16 illustrates one threaded pneumatic silencer 1660. Pneumatic silencer 1660 is an embodiment of pneumatic silencer 1560 that includes a porous body 1662 and a threaded end 1664. When implemented in nozzle 1500, threaded end 1664 is threaded into an opening in wall 1538. Porous body 1662 includes a porous material that diffuses gas flow therethrough, as discussed above for pneumatic silencer 1560 in reference to FIG. 15. In an alternative embodiment, not depicted, porous body 1662 is fully or partly positioned inside threaded end 1664.

Laser welding method 102 may be extended to laser welding of a plurality of battery cells 100. Such multi-unit embodiments of laser welding method 102 may utilize a separate instance of nozzle 200 for each battery cell 100. However, a single instance of laser 270 and beam-steering module 280 suffices. Multi-unit embodiments of laser welding method 102 may thereby provide an increased throughput rate with only relatively little added apparatus cost, as compared to single-unit embodiments of laser welding method 102.

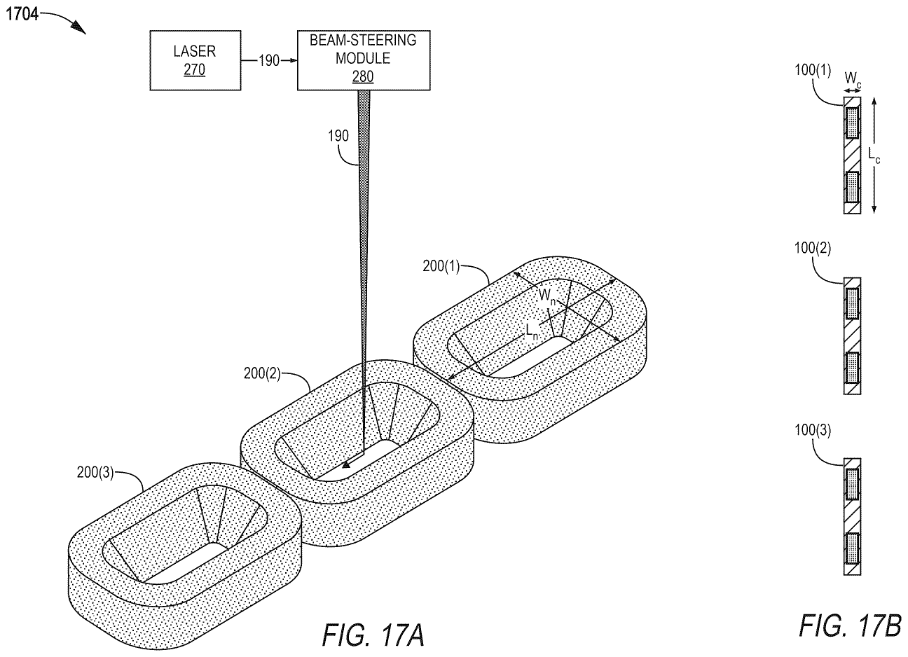

FIGS. 17A and 17B illustrate one laser welding apparatus 1704 for laser welding cap 112 to case body 110 in a series of battery cells 100 arranged next to each other in a lengthwise linear array. Laser welding apparatus 1704 includes a separate nozzle 200 for each battery cell 100 of the series. FIG. 17A is a perspective view of laser welding apparatus 1704, and FIG. 17B is a top view of the linear array of battery cells 100 arranged to be welded by laser welding apparatus 1704. In operation, beam-steering module 280 steers laser beam 190 to address each battery cell 100 through central opening 220 of a respective nozzle 200.

Typically, cap 112 (see FIGS. 1A and 1B) of battery cell 100 is elongated in one dimension, resulting in each battery cell 100, in the top-view of FIG. 17A, having a length L_{c} and a comparatively smaller width W_{c}. Each nozzle 200 has corresponding length Lₙ and comparatively smaller width Wₙ. The linear array of battery cells 100, and the associated linear array of nozzles 200, are oriented along the lengthwise dimension.

In the depicted example, laser welding apparatus 1704 is configured to laser weld three battery cells 100 and therefore includes three nozzles 200. More generally, laser welding apparatus 1704 may include two or more nozzles 200 to laser weld two or more battery cells 100.

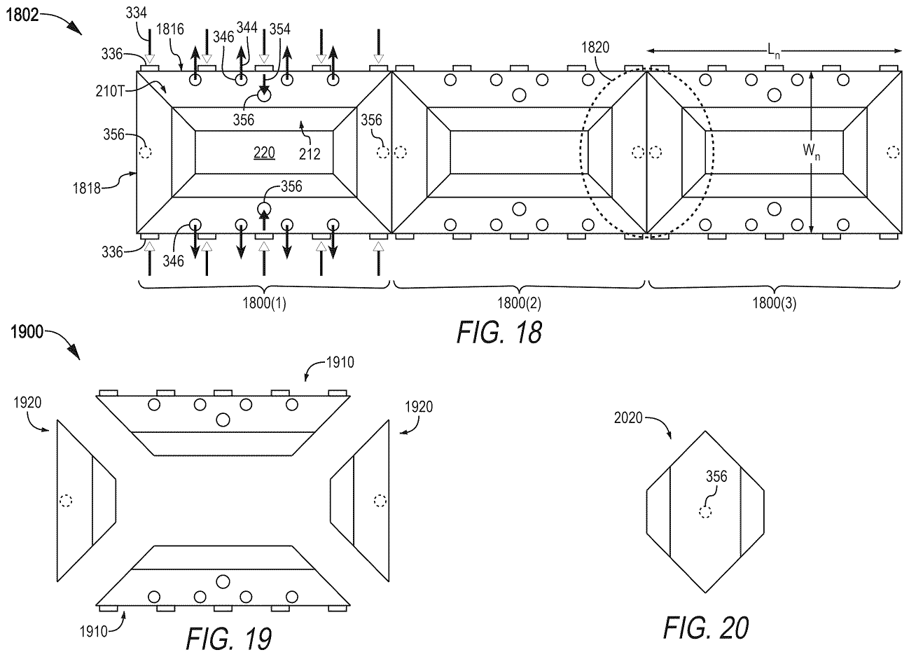

FIG. 18 is a top-view of one nozzle assembly 1802 that may be implemented in laser welding apparatus 1704. Nozzle assembly 1802 includes a series of gas-flow nozzles 1800 arranged in a lengthwise linear array. In each nozzle 1800, (a) one or more inlet ports 336 for lower gas flow 334 are positioned in each lengthwise side 1816, (b) one or more outlet ports 346 for exhaust flow 344 are positioned in each lengthwise side 1816 or in top 210T between each lengthwise side 1816 and central opening 220, and (c) at least one inlet port 356 for upper gas flow 354 is positioned in each lengthwise side 1816 or in top 210T between each lengthwise side 1816 and central opening 220. Optionally, at least one additional inlet port 356 for upper gas flow 354 is positioned in top 210T between each widthwise side 1818 of nozzle 1800 and central opening 220. This arrangement of inlet and outlet ports allows nozzles 1800 or nozzle assembly 1802 to be immediately adjacent to each other with no gaps therebetween, thereby minimizing the required field of view of beam-steering module 280.

Herein, a “lengthwise side” is a side that is oriented along the lengthwise dimension, and a “widthwise side” is a side that is oriented along the widthwise dimension.

In one embodiment, nozzles 1800 of nozzle assembly 1802 are integrally formed with each other. In another embodiment, nozzle assembly 1802 is formed by positioning separate nozzles 1800 next to each other. In this embodiment, nozzles 1800 may be attached to each other. In yet another embodiment, each nozzle 1800 of nozzle assembly 1802 is composed of modules that can be attached to each other. Some of these modules may be shared between adjacent nozzles 1800.

FIG. 19 is an exploded top-view of one modular gas-flow nozzle 1900. Nozzle 1900 is an embodiment of nozzle 1800 including two lengthwise modules 1910 and two widthwise modules 1920. Nozzle 1900 is not limited to laser welding apparatuses configured with a plurality of gas-flow nozzles. Nozzle 1900 may also be implemented in laser welding apparatus 204 as the only gas-flow nozzle.

FIG. 20 is a top-view of one gas-flow module 2020 that may be implemented in modular embodiments of nozzle assembly 1802 to form widthwise portions of two adjacent nozzles 1800 (see, e.g., region 1820 in FIG. 18). For example, the embodiment of nozzle assembly 1802 depicted in FIG. 18 may be composed of (from left to right) a widthwise module 1920, two lengthwise modules 1910, a module 2020, two lengthwise modules 1910, a module 2020, two lengthwise modules 1910, and a widthwise module 1920. Module 2020 may include an inlet port 356 for upper gas flow 354 to both of the two associated gas-flow nozzles 1800.

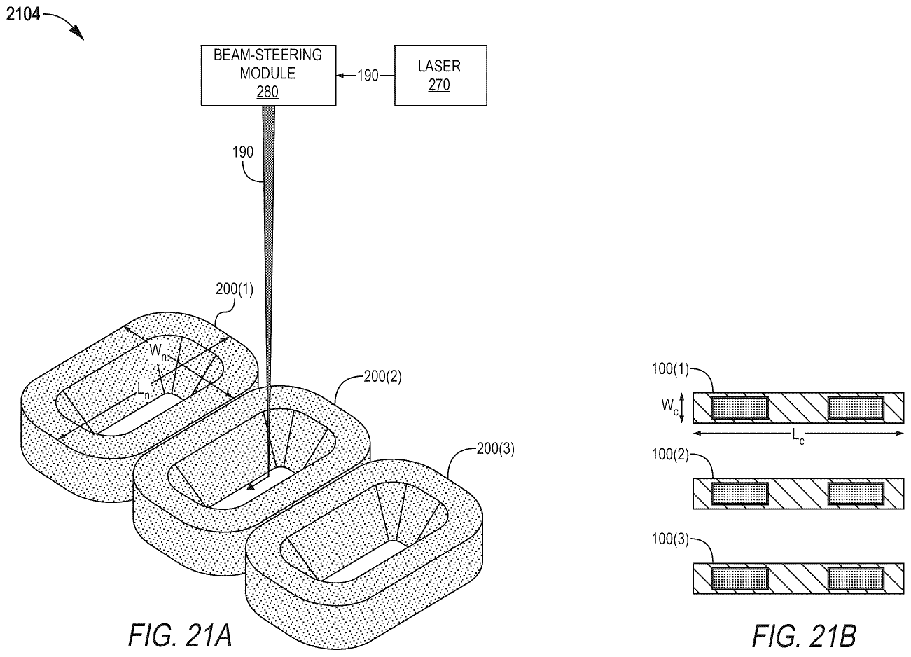

FIGS. 21A and 21B illustrate one laser welding apparatus 2104 for laser welding cap 112 to case body 110 of a series of battery cells 100 arranged next to each other in a widthwise linear array. Laser welding apparatus 2104 is a modification of laser welding apparatus 1704, wherein the linear array of nozzles 200 is oriented widthwise instead of lengthwise. FIG. 21A is a perspective view of laser welding apparatus 2104, and FIG. 21B is a top view of the linear array of battery cells 100 arranged to be welded by laser welding apparatus 2104.

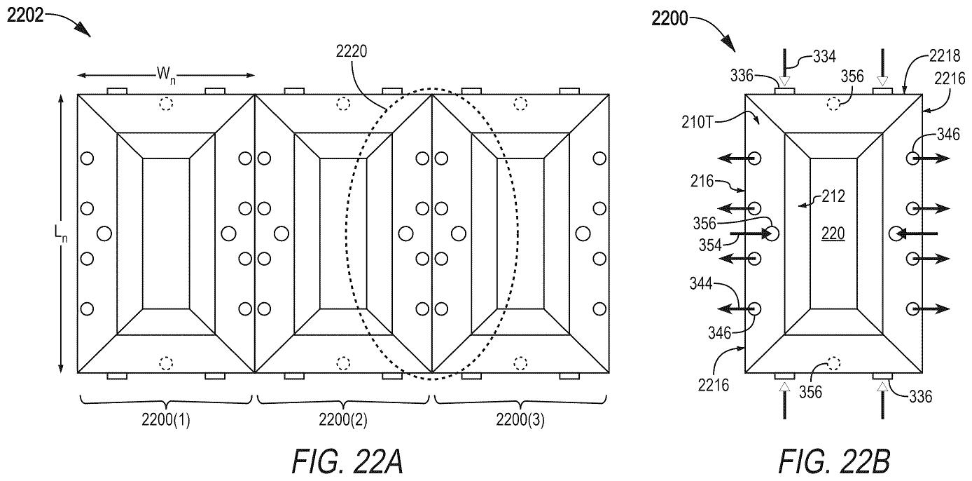

FIGS. 22A and 22B illustrate one nozzle assembly 2202 that may be implemented in laser welding apparatus 2104. Nozzle assembly 2202 includes a series of gas-flow nozzles 2200 arranged in a widthwise linear array. FIG. 22A is a top-view of nozzle assembly 2202, and FIG. 22B is a top-view of a single nozzle 2200 showing further detail.

In each nozzle 2200, (a) one or more inlet ports 336 for lower gas flow 334 are positioned in each widthwise side 2218 and (b) one or more outlet ports 346 for exhaust flow 344 and at least one inlet port 356 for upper gas flow 354 are positioned in top 210T between each lengthwise side 2216 and central opening 220. Optionally, at least one additional inlet port 356 for upper gas flow 354 is positioned in top 210T between each widthwise side 2218 and central opening 220. This arrangement of inlet and outlet ports allows nozzles 2200 of nozzle assembly 2202 to be immediately adjacent to each other with no gap therebetween.

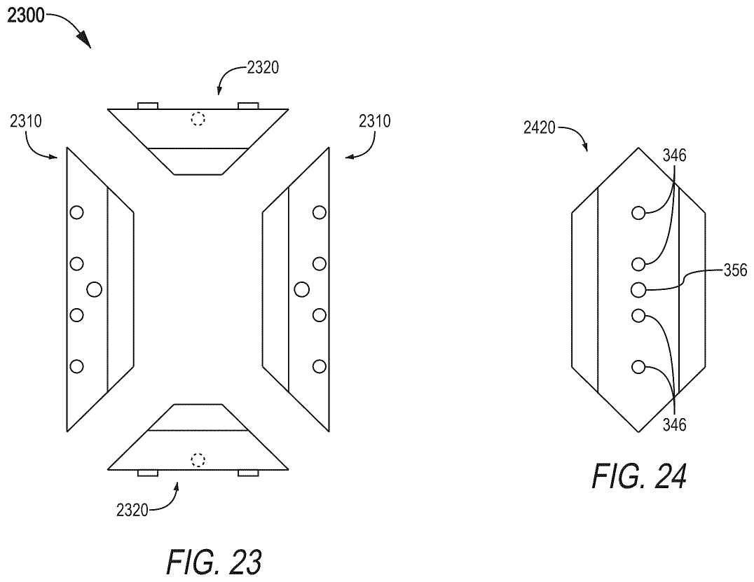

FIG. 23 is an exploded top-view of one modular gas-flow nozzle 2300 that may be implemented in nozzle assembly 2202. Nozzle 2300 is a modification of nozzle 1900 where inlet and outlet ports are arranged as in nozzle 2200. Nozzle 2300 includes two lengthwise modules 2310 and two widthwise modules 2320.

FIG. 24 is a top-view of one gas-flow module 2420 that may be implemented in modular embodiments of nozzle assembly 2202 to form lengthwise portions of two adjacent nozzles 2200 (see, e.g., region 2220 in FIG. 22). For example, the embodiment of nozzle assembly 2202 depicted in FIG. 22 may be composed of (from left to right) a lengthwise module 2310, two widthwise modules 2320, a module 2420, two widthwise modules 2320, a module 2420, two widthwise modules 2320, and a lengthwise module 2310. Module 2420 may include (a) one or more outlet ports 346 for exhaust flow 344 from both of the two associated gas-flow nozzles 2200 and (b) an inlet port 356 for upper gas flow 354 to both of the two associated gas-flow nozzles 2200.

Referring now to FIGS. 17-24 collectively, laser welding apparatuses 1704 and 2104, and the associated nozzles 200, are readily generalized to laser welding of battery cells 100 with non-elongated caps 112. In such scenarios, laser welding apparatuses 1704 and 2104 may implement nozzles 200 with similarly sized length Lₙ and width Wₙ. Similarly, each individual nozzle 1800 of nozzle assembly 1802 and each individual nozzle 2200 of nozzle assembly 2202 may have similarly sized length and width, and associated embodiments of modules 1910, 1920, 2020, 2310, 2320, and 2420 may be configured accordingly. The concepts of FIGS. 17-24 are also readily extended to laser welding of 2D arrays of prismatic battery cells. Additionally, laser apparatuses 1704 and 2104 may be modified to laser weld a plurality of prismatic battery cells positioned near each other in an arrangement that is not a linear or rectangular array.

The use of nozzle 200 and its embodiments, e.g., nozzles 400, 500, 600, 700, 1300, 1400, 1500, 1800, 1900, 2200, and 2300 is not limited to laser welding of prismatic battery cells. More generally, these nozzles are useful for laser welding tasks that involve laser welding close to a material that is heat sensitive and may be damaged by the plume, plasma, and/or heat generated by the laser welding process. Similarly, laser welding method 102 and its embodiments and extensions, as well as laser welding apparatuses 204, 1704, and 2104 and their embodiments and extensions, may be applied to other workpieces than prismatic battery cells.

The present invention is described above in terms of a preferred embodiment and other embodiments. The invention is not limited, however, to the embodiments described and depicted herein. Rather, the invention is limited only by the claims appended hereto.

What is claimed is:

1. A laser welding apparatus, comprising:
a gas-flow nozzle including:
a central opening to transmit a laser beam from a top of the central opening to a workpiece at a bottom of the central opening, the central opening being bounded by two inward-facing opposite sides of the gas-flow nozzle;
one or more lower gas-flow channels to direct a lower gas flow to the workpiece from both of the two inward-facing opposite sides bounding the central opening, the one or more lower gas-flow channels having one or more lower outlet ports at the central opening;
one or more upper gas-flow channels to direct an upper gas flow to the workpiece from both of the two inward-facing opposite sides bounding the central opening, the one or more upper gas-flow channels having one or more upper outlet ports at the central opening; and
one or more middle gas-flow channels to exhaust gas from both of the two inward-facing opposite sides bounding the central opening, the one or more middle gas-flow channels having one or more inlet ports at the central opening;
wherein the upper outlet ports are arranged in an upper layer of the gas-flow nozzle between the top and the bottom of the central opening, the lower outlet ports are arranged in a lower layer of the gas-flow nozzle farther than the upper layer from the top of the central opening, and the inlet ports are arranged in a middle layer of the gas-flow nozzle between the lower and upper layers.

2. The laser welding apparatus of claim 1, wherein, for each of the one or more upper outlet ports, the upper gas flow emanates from the upper outlet port in a direction that is toward the bottom of the central opening and toward a center plane between the two inward-facing opposite sides bounding the central opening.

3. The laser welding apparatus of claim 1, wherein the one or more lower outlet ports include a lower annular outlet port surrounding the central opening.

4. The laser welding apparatus of claim 3, wherein the one or more upper outlet ports include an upper annular outlet port surrounding the central opening.

5. The laser welding apparatus of claim 3, wherein the one or more upper outlet ports includes one upper outlet port on each of the two inward-facing opposite sides bounding the central opening.

6. The laser welding apparatus of claim 3, wherein the one or more upper outlet ports includes two upper outlet ports positioned on each of the two inward-facing opposite sides bounding the central opening.

7. The laser welding apparatus of claim 3, wherein the one or more inlet ports include an annular inlet port surrounding the central opening.

8. The laser welding apparatus of claim 3, wherein the lower annular outlet port includes a baffle directing the lower gas flow, from each of the two inward-facing opposite sides bounding the central opening, to emanate from the annular outlet port along an oblique direction, a projection of the oblique direction onto the bottom of the central opening being at an oblique angle to a center plane between the two inward-facing opposite sides bounding the central opening.

9. The laser welding apparatus of claim 1, wherein the two inward-facing opposite sides are farther apart from each other at the top of the central opening than at the bottom bounding the central opening.

10. The laser welding apparatus of claim 1, wherein the two inward-facing opposite sides bounding the central opening extend along an elongated dimension of the central opening.

11. The laser welding apparatus of claim 1, further comprising:
at least one gas source coupled to the one or more lower gas-flow channels and the one or more upper gas-flow channels; and
a gas extractor coupled to the middle gas-flow channels.

12. The laser welding apparatus of claim 1, further comprising:
a laser to generate the laser beam; and
a beam-steering module to trace a path on the workpiece with the laser beam.

13. The laser welding apparatus of claim 1, wherein the nozzle further includes a baffle directing the lower gas flow, from each of the two inward-facing opposite sides bounding the central opening, to emanate from the one or more lower gas-flow channels along an oblique direction, a projection of the oblique direction onto the bottom of the central opening being at an oblique angle to a center plane between the two inward-facing opposite sides bounding the central opening.

14. The laser welding apparatus of claim 13, wherein the baffle forms a plurality of separate sub-channels, each of the plurality of separate sub-channels being oriented along the oblique direction.

15. The laser welding apparatus of claim 13, wherein the baffle includes a plurality of walls, protruding into the one or more lower gas-flow channels, to direct the lower gas flow to emanate from the one or more lower gas-flow channels along the oblique direction, each of the plurality of walls being oriented along the oblique direction and protruding into the one or more lower gas-flow channels from a floor or a ceiling of the one or more lower gas-flow channels, the ceiling being closer than the floor to the top of the central opening.

16. The laser welding apparatus of claim 15, wherein each of the plurality of walls span only partway between the floor and the ceiling.

17. The laser welding apparatus of claim 15, wherein each of the plurality of walls span between the floor and the ceiling to form a plurality of separate, lower outlet ports.

18. The laser welding apparatus of claim 1, wherein the one or more lower gas-flow channels include a plurality of perforated or porous barriers arranged such that the lower gas-flow emanating from each of the one or more the lower outlet ports has passed through a series of the perforated or porous barriers.

19. The laser welding apparatus of claim 18, wherein the series of perforated or porous barriers includes at least one rigid wall with holes and at least one mesh, the at least one mesh being closer than the at least one rigid wall to the one or more the lower outlet ports.

20. The laser welding apparatus of claim 1, further comprising a plurality of pneumatic silencers disposed in the one of more lower gas-flow channels, wherein the one or more lower gas-flow channels includes one or more walls blocking the lower gas flow except for through a plurality of openings, each of the openings directing a respective portion of the lower gas flow through a respective one of the pneumatic silencers.

21. The laser welding apparatus of claim 1, wherein the gas-flow nozzle is one instance of a plurality of gas-flow nozzles of the apparatus arranged next to each other to address a respective plurality of workpieces.

22. The laser welding apparatus of claim 21, wherein each of the gas-flow nozzles has a length and a width, the width being shorter than the length, the plurality of gas-flow nozzles being arranged in a linear array parallel to the length of each of the gas-flow nozzles.

23. The laser welding apparatus of claim 21, wherein each of the gas-flow nozzles has a length and a width, the width being shorter than the length, the plurality of gas-flow nozzles being arranged in a linear array parallel to the width of each of the gas-flow nozzles.

24. A laser welding method, comprising steps of:
positioning the gas-flow nozzle of claim 1 at a prismatic battery cell such that a cap of the prismatic battery cell is located at the bottom of the central opening and faces the top of the central opening, the cap including at least one terminal having insulator material facing both of the inward-facing opposite sides bounding the central opening;
tracing an annular interface between the cap and a case body of the prismatic battery cell with the laser beam to laser weld the cap to the case body, said tracing including directing the laser beam into the central opening to reach the annular interface; and
while tracing the annular interface, forcing gas into the one or more lower gas-flow channels and the one or more upper gas-flow channels to form the lower and upper gas flows, and exhausting gas via the one or more middle gas-flow channels.

25. The laser welding method of claim 24, wherein, when the step of tracing the annular interface scans an incidence location of the laser beam along an adjacent one of the two inward-facing opposite sides bounding the central opening, the step of forcing directs the lower gas flow, emanating from the adjacent one of the two inward-facing opposite sides, in a direction that has a component counter to a scanning direction of the incidence location.
